(19) United States
(12) Patent Application Publication
(10) Pub. No.: US 2010/0248186 A1
(43) Pub. Date: Sep. 30, 2010

(54) Assembly For Supporting At Least One Artificial Dental Element

(76) Inventor: Antonius Johannes Van Werkhoven, Oisterwijk (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/665,768

(22) PCT Filed: Jun. 24, 2008
(86) PCT No.: PCT/NL08/00160

§ 371 Date: May 10, 2010

(51) Int. Cl. A61C 8/00

(52) U.S. Cl. 433/173

(57) ABSTRACT

An assembly (3) comprises at least two implants (11) which are destined to be inserted in a jaw (10); a primary part (26) per implant (11), having a through-hole (27), which is destined to be connected to the implant (11); and a secondary part (28) which is destined to be placed on the primary parts (26). At one side, the secondary part (28) has spaces (29) for receiving the primary parts (26), and, at another side, holes (32) giving access to the spaces (29). As a consequence, it is possible to reach the primary parts (26) for the purpose of fixing them in the implants (11), and to keep these parts (26) in a desired positioning with the help of the secondary part (28) at the same time. Also, a choice between a detachable frictional coupling and a fixed connection between the said parts (26, 28) is possible.

The invention relates to an assembly which is destined to be anchored in a jaw of a user person, and which serves for supporting at least one artificial dental element, comprising at least two implants which are destined to be inserted in a jaw of a user person.

Such an assembly is known in practice, in various embodiments, and is applied more and more, as a result of which application of the traditional dentures is more and more restricted. The assembly is exceedingly suitable to be used when only a few teeth and/or molars need to be replaced by artificial dental elements, but may also be used in the case of a jaw in which not a single natural tooth or molar is present.

In a first known embodiment, besides the implants, the assembly comprises a part which is generally known by the name bridge, and which is destined to be fixed to the implants. In that case, at least one artificial dental element is arranged on this bridge.

The assembly having the implants and the bridge is manufactured and put in place by carrying out the following steps:

providing the implants;

inserting the implants in a jaw of a user person;

making an imprint of the implants as being present in the jaw of the user person;

manufacturing a model of the implants, wherein the positioning of the implants in the model corresponds to the positioning of the implants in the jaw of the user person;

making a bridge on the model, wherein, for example, a modeling technique or cad-cam may be applied;

arranging one or more dental elements on the bridge, wherein the dental elements are manufactured from baked porcelain, for example;

fixing the whole of the bridge with the at least one dental element on the implants.

The latter step is carried out by screwing the bridge on the implants, or sticking the bridge to the implants, for example. In the first case, screw holes are present in the whole of the bridge with the at least one dental element. They are closed after the bridge has been put in place, by applying, for example, a filler material which is known by the name composite.

For sake of completeness, it is noted that the term “cad” is a known abbreviation which stands for designing with the help of the computer (computer aided design), while the term “cam” is a known abbreviation which stands for manufacturing with the help of the computer (computer aided manufacturing).

An advantage of the application of the assembly having the implants and the bridge is that a user thereof has the feeling of having something in the mouth that is fixed. However, there are also disadvantages which are related to this assembly. In the following, a short list of a number of these disadvantages will be given.

Due to the fact that the assembly is not removable, it is difficult to keep the assembly and the direct surroundings in the user's mouth clean.

The assembly can no longer be used when an implant is lost.

Repair of the assembly is bothersome, or even impossible. When the bridge is screwed on the implants, the screw holes need to be opened, and all screw connections need to be disconnected. When the bridge is stuck to the implants, repair is often impossible.

The assembly cannot be applied in all cases. Especially in a case of resorption of the jaw bone to a large extent, another solution to placing artificial dental parts in the mouth needs to be found.

In the case of advancing resorption, an unpleasant appearance is obtained, because more and more space comes to being between a bottom side of the bridge and the jaw bone.

When the imprint of the implants is inaccurate, a non-fitting bridge is obtained, which cannot be used.

Another known assembly provides for a removability of a part of the assembly, namely a part of the assembly on which the at least one artificial dental element is situated. Such an assembly is known by the name telescope/cone construction. The word “cone” is related to the fact that the assembly comprises parts which are usually shaped like a truncate cone. In particular, besides the implants, a telescope/cone construction comprises the following components:

a primary part per implant, which is destined to be placed on the implant and to be connected to the implant;

a cap per primary part, which is destined to be placed over the primary part in a tightly-fitting fashion; and

a secondary part which has spaces for receiving the caps arranged therein at one side, wherein a whole of secondary part and caps is destined to be placed on the primary parts.

In the telescope/cone construction, the at least one artificial dental element is placed on the secondary part. Furthermore, on the basis of a conical shape of the primary parts and the tight fitting of the caps on the primary parts, a good frictional coupling is obtained. In particular, due to this, it is achieved that a whole of secondary part and caps may be removed from the primary parts, while all components of the construction stay at a fixed position during normal use. Hence, a user of the telescope/cone construction has the feeling of having something in the mouth that is fixed on the one hand, while it is possible to remove a part thereof on the other hand, so that cleaning of the implants in the mouth and repair of the construction may be carried out well. The fact that a part of the construction is removable does not only have advantages, but also has the disadvantage that retention may be list in the course of time, as a result of which the construction needs to be adapted or even needs to be replaced.

Another disadvantage of the telescope/cone construction is that manufacturing and placing thereof needs to take place with high accuracy, and that these are labour-intensive processes, as a result of which the costs are relatively high. In particular, manufacturing the telescope/cone construction and putting the telescope/cone construction in place comprises the following steps:

providing the implants;

inserting the implants in a jaw of a user person;

making an imprint of the implants as being present in the jaw of the user person;

manufacturing a model of the implants, wherein the positioning of the implants in the model corresponds to the positioning of the implants in the jaw of the user person;

manufacturing the primary parts on the model, wherein a primary part is provided per implant;

manufacturing the caps on the primary parts;

making the secondary part on which the at least one artificial dental element is placed such as to cover the caps;

attaching the caps to the secondary part, for example, by means of soldering or sticking;

making a transfer key for the purpose of being able to place the primary parts in the mouth of a user person in such a way that the whole of the secondary part and the caps fits exactly on the primary parts;

placing the primary parts in the mouth of the user person with the help of the transfer key, wherein the primary parts are temporarily connected to the implants, and wherein it is checked whether the entire construction can be built up in the mouth of the user person in the correct way;

removing the primary parts, and further finishing the construction, wherein the primary parts are applied; and

repeating the processes of putting the primary parts and the other parts of the construction in place, and removing the primary parts, until the construction that is actually realized is right.

In the process of putting the primary parts of the telescope/cone construction in place, it is required to apply a transfer key, because these parts may turn. Only by preventing this from happening, it is possible that the whole of secondary part and caps in the mouth of a user person fits on the primary parts in the same way as is the case with the model.

According to the invention, the steps of manufacturing the various parts of the telescope/cone construction and the transfer key may be carried out by applying cad/cam. Advantages of doing so are that it is possible to work in an accurate way, and that the data of specific cases can be stored in the computer.

The invention provides an assembly which is destined to be anchored in a jaw of a user person, and which serves for supporting at least one artificial dental element, wherein the assembly is designed differently than the above-mentioned known constructions, and wherein, consequently, the assembly does not have a number of disadvantages of these constructions. In particular, the invention provides an assembly, comprising the following components:
at least two implants which are destined to be inserted in a jaw of a user person;

a primary part per implant, which is destined to be placed on the implant and to be connected to the implant; and

a secondary part which is destined to be placed on the primary part, which has spaces for receiving the primary parts arranged therein at one side, and which, at another side, and at the position of the spaces, has holes giving access to the spaces; wherein the primary part is provided with a through-hole.

In the assembly of the invention, the at least one dental element can be arranged on the part which is denoted as secondary part.

A special aspect of the assembly according to the invention is the fact that the secondary part has spaces for receiving the primary parts arranged therein at one side, and, at another side, and at the position of the spaces, has holes giving access to the spaces, while the primary parts are provided with through-holes. According to an insight on which the invention is based, this design of the assembly makes it possible that positioning the primary parts in the mouth of a user person costs much less trouble than with the known telescope/cone construction which has comparable parts, wherein the use of a transfer key may be omitted. This is caused by the fact that application of the invention offers the possibility of connecting the primary parts to the implants while the secondary part is placed on the primary parts. The primary parts may namely be reached, through the holes in the secondary part, and, in turn, the implants may be reached through the through-holes in the primary parts. In the known telescope/cone construction, the whole of the secondary part and the caps cannot be used in positioning the primary parts, because this whole encloses the primary parts, as a result of which these parts cannot be reached from the outside. Even if holes would be present in the secondary part, as is the case in a construction which is known from U.S. Pat. No. 4,772,204, for example, a separate transfer key is still required, as until now, it is not foreseen to have through-holes in the primary parts, so that it is not possible to establish a connection between the primary parts and the implants while the secondary part is applied as transfer key.

The implants may have blind holes, and because the primary parts are having through-holes, it is possible to insert an attachment element per primary part, which is first moved through the hole of the secondary part which gives access to the space in the secondary part in which the primary part is situated, and which is subsequently provided with a position in which it is extending partially in the primary part and partially in the associated implant, and wherein it connects the primary part to the implant by doing so. The attachment element may be a screw, wherein, for example, at least a portion of a surface of the implant is provided with internal thread at the position of the hole, and wherein the hole which is present in the primary part has at least two portions having different diameters, wherein a portion which is positioned at the side of the implant has a diameter which is sufficient to allow a threaded shank of the screw to pass through, and which is insufficient to allow a head of the screw to pass through, while the other portion is different in the sense of being capable of allowing the entire screw to pass through.

Because of the fact that the secondary part has holes, the possibility to connect the secondary part to the primary parts exists. When the primary part has a hole arranged therein, a portion of a surface of the primary part at the position of the hole may be provided with internal thread, so that a screw may be applied to connect the secondary part to the primary parts. In that case, the secondary part may be adapted for retaining a head of the screw and allowing a shank of the screw to pass through without hindrance.

As indicated in the preceding paragraph, the secondary part may be connected to the primary parts as a bridge, if so desired. However, it is also possible that a only a frictional coupling is established between the secondary part and the primary parts, as is the case in the known telescope/cone construction. In that case, it is advantageous when the primary parts are shaped like a truncate cone, and a shape of the spaces which are present in the secondary part are adapted to the shape of the primary parts in such a way that the primary parts can be snugly received therein. The possibility of choosing between a totally fixed connection (such as a screw connection) and a detachable connection (such as a frictional coupling) between the secondary part and the primary parts is an important advantage which is offered by the invention.

Preferably, for the purpose of manufacturing the primary parts and the secondary part, use is made of the computer to determine and realize a suitable design of these parts. The fact is that this has many advantages. Among other things, the application of the computer provides for saving of time, lightening the task of a person manufacturing the assembly, and high accuracy. Moreover, the application of the computer allows for archiving data, which may be advantageous in case repair of an assembly is required, or when an assembly needs to be replaced in its entirety. In particular, the assembly of the invention can be manufactured by carrying out the following steps, assuming that implants are already arranged in a jaw of a user person:

making an imprint of the implants such as being present in the jaw of the user person;

manufacturing a model of the implants, wherein the positioning of the implants in the model corresponds to the positioning of the implants in the jaw of the user person;

subjecting the model to software-aided scanning;

software-aided modeling the primary parts and the secondary part; and

manufacturing the primary parts and the secondary part through cad/cam milling techniques.

As already noted, putting the assembly according to the invention in place is relatively simple, mainly because there is no need for a transfer key to realize that the primary parts are provided with a certain place and orientation in the mouth of a user person. In fact, in the process of arranging the assembly on a jaw of a user person, the secondary part itself is used as transfer key, wherein the primary parts are connected to the implants while the secondary part is situated on the primary parts. In general, a method for placing an assembly according to the invention on implants as being present in a jaw of a user person comprises the following steps:

placing the primary parts on the implants, and the secondary part on the primary parts; and

connecting the primary parts to the implants while these parts are situated in the spaces in the secondary part, by applying connection elements, wherein the attachment elements are moved through the holes in the secondary part.

The invention will be explained in more detail on the basis of the following description. In the process, reference will be made to the drawing, in which equal reference signs indicate equal or similar components, and in which:

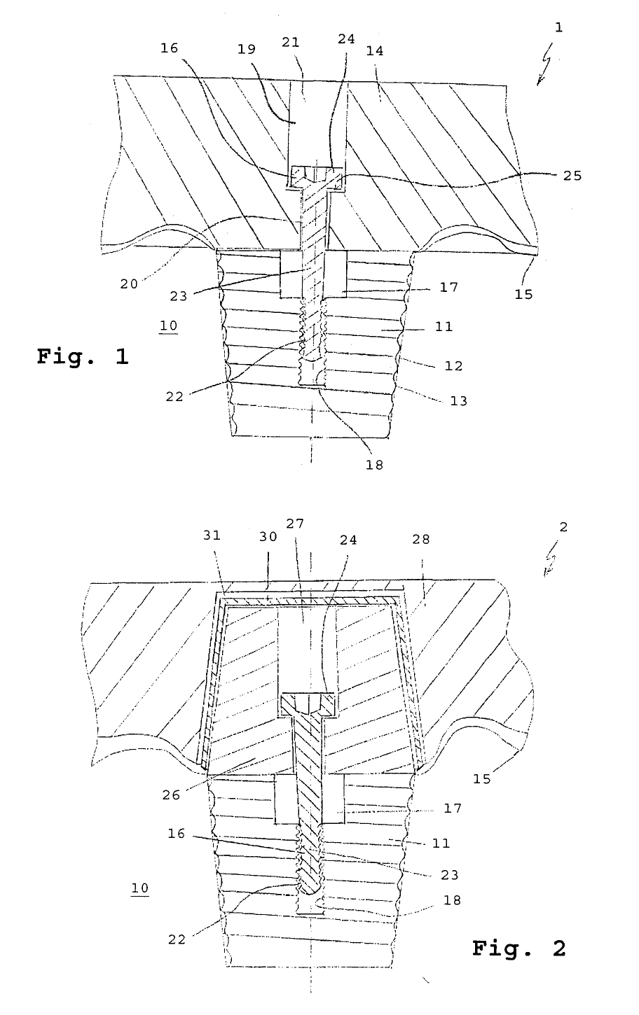

FIG. 1 is a diagrammatic sectional drawing of a portion of a first variant of an assembly according to the state of the art;

FIG. 2 is a diagrammatic sectional drawing of a portion of a second variant of an assembly according to the state of the art;

FIGS. 3-5 are diagrammatic sectional views of parts of the assembly as shown in FIG. 2;

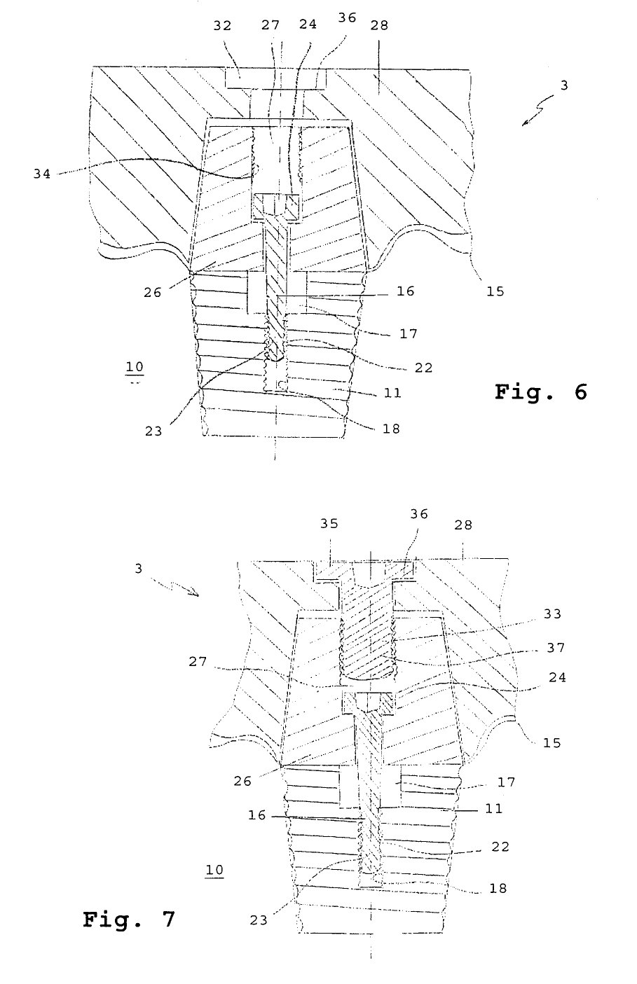

FIGS. 6 and 7 are diagrammatic sectional drawings of a portion of an assembly in a preferred embodiment of the invention; and

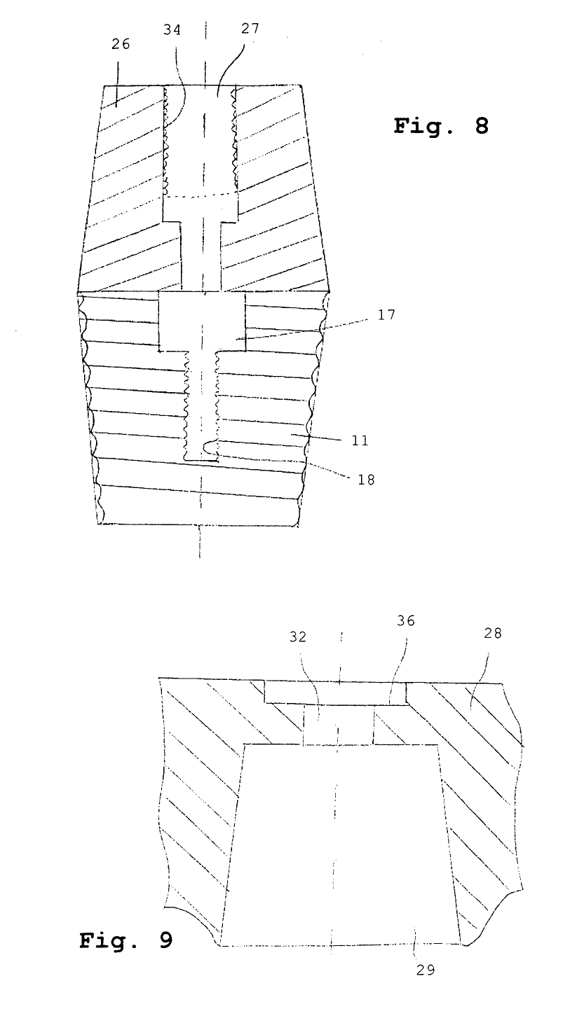

FIGS. 8 and 9 are diagrammatic sectional views of parts of the assembly as shown in FIGS. 6 and 7.

Prior to explaining the invention itself in more detail, the background of the invention will now be sketched first on the basis of the following description of two known assemblies 1, 2 which are destined to be anchored in a jaw of a user person, and which serve for supporting at least one artificial dental element. For sake of completeness, it is noted that for sake of clarity, none of the figures shows the artificial dental elements. Moreover, artificial dental elements such as artificial teeth and artificial molars are known per se, as a result of which omitting a further explanation is justified.

FIG. 1 shows a portion of the first known assembly 1, which will hereinafter be indicated as bridge construction 1. FIG. 1 shows the bridge construction 1 in a mounted condition, wherein it is anchored in a jaw 10 of a user person.

The bridge construction 1 comprises a number of implants 11, usually at least four of them, which are arranged in the jaw 10. One of these implants 11 is shown in FIG. 1. Various embodiments of the implants 11 are known. In the shown example, the implant 11 is shaped like a truncate cone. An exterior surface 12 of the implant 11 is provided with thread 13 for primary fixation in the jaw 10. When an implant 11 is inserted in the jaw 10 of a user person, it gets well fixed over time as the bone grows around the implant 11. A common material for the implant 11 is titanium.

The bridge construction 1 further comprises a bridge 14 which is fixed to the implants 11. The bridge 14 is part of the assembly 1 which is situated above the gums 15, and functions as carrier for at least one artificial dental element (not shown). A portion of the bridge 14 is shown in FIG. 1.

In the shown example, the bridge 14 is attached to the implants 11 by means of screws 16. One of these screws 16 is shown in FIG. 1. For the purpose of realizing the screw connection, a blind hole 17 which is partially provided with thread 18 is situated in the implant 11, and the bridge 14 is provided with through-holes 19 having two portions 20, 21 having different diameters. In this case, it is important that the mutual positioning of the holes 19 corresponds to the mutual positioning of the implants 11. Therefore, the bridge 14 is a part which is manufactured with high accuracy.

In particular, a portion 20 of the through-hole 19 in the bridge 14 which is situated at the side of the connection of the bridge 14 to the implant 11 has a smaller diameter than the other portion 21. The screw connection has been established by partly inserting a screw 16 in the hole 17 of the implant 11, through the through-hole 19 in the bridge 14, wherein thread 22 on a shank 23 of the screw 16 and thread 18 of the implant 11 have been put to mutual engagement. In the process, the screw 16 has been moved further and further in the direction of the implant 11, until a head 24 of the screw 16 abutted against a transition surface. 25 between the two portions 20, 21 of the hole 19 of the bridge 14 having the different diameters. For sake of completeness, it is noted that the dimensions of the screw 16 and the diameter of the portion 20 of the through-hole 19 in the bridge 14 which is situated at the side of the connection of the bridge 14 to the implant 11 are adapted to each other in such a way that the said portion 20 of the through-hole 19 is only capable of allowing the shank 23 of the screw 16, which has a smaller diameter than the head 24 of the screw 16, to pass through.

During a process of arranging the bridge construction 1 in the mouth of a user person, after inserting the screws 16, an open portion of the holes 19 in the bridge 14 is filled with a suitable material, for example, composite. After the bridge 14 has been fixed on the implants 11 with the help of the screws 16, the bridge construction 1 is totally fixed to the jaw 10.

FIG. 2 shows a portion of a second known assembly 2, which will hereinafter be indicated as telescope/cone construction 2. FIG. 2 shows the telescope/cone construction 2 in a mounted condition, in which it is anchored in a jaw 10 of a user person. The telescope/cone construction 2 has a totally different structure than the bridge construction 1, and provides for the possibility for a user person to remove a part of the construction 2, in particular a part of the construction 2 on which at least one artificial dental element (not shown) is situated, if so desired.

Like the bridge construction 1, the telescope/cone construction 2 comprises a number of implants 11, wherein the minimum number of implants 11 is two. One of these implants 11 is shown in FIG. 2. A primary part 26 is screwed on each implant 11. In the shown example, the way in which the primary parts 26 are connected to the implants 11 by means of a screw 16 is comparable to the way in which the bridge 14 of the bridge construction 1 is connected to the implants 11, and will therefore not be explained in more detail. In a comparable manner as in the bridge 14 of the bridge construction 1, the primary parts 26 are provided with through-holes 27. A whole of an implant 11 and a primary part 26 connected thereto is also shown in FIG. 3, wherein the screw 16 is omitted for sake of clarity.

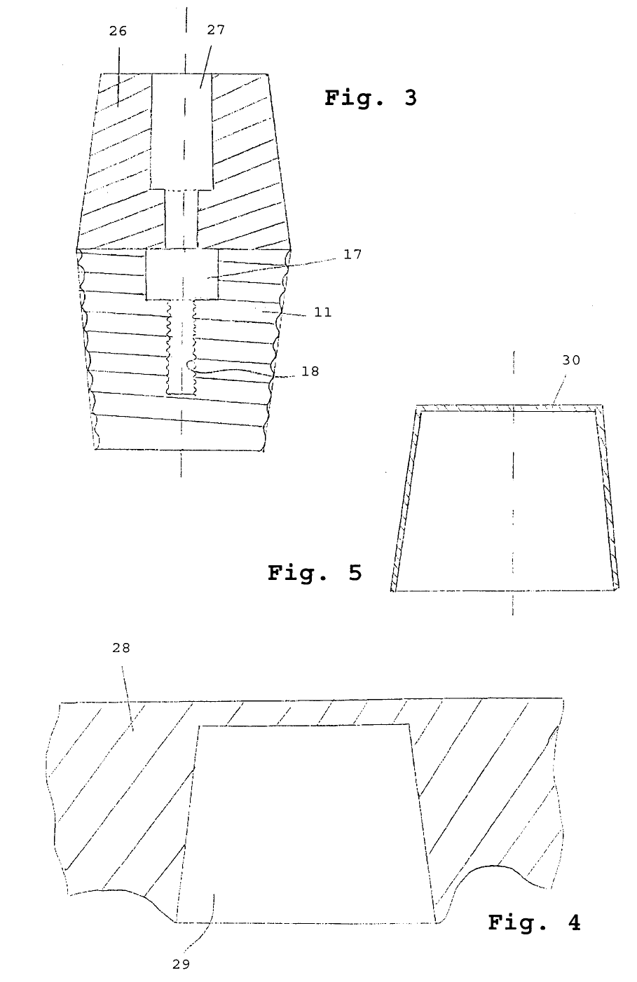

The telescope/cone construction further comprises a secondary part 28, of which a portion is shown in FIG. 2. Additionally, this portion is separately shown in FIG. 4. At one side, the secondary part 28 is provided with spaces 29 for accommodating caps 30 which are arranged over the primary parts 26 in a tightly-fitting fashion, wherein a frictional coupling between the primary parts 26 on the one hand and the secondary part 28 with the caps 30 on the other hand has been established. The caps 30 are connected to the secondary part 28, for example, by means of a glue or solder connection 31. In FIG. 2, one of the caps 30 is shown, whereas FIG. 5 shows a separate cap 30.

In the telescope/cone construction 2, the frictional coupling between the primary parts 26 on the one hand and the whole of the secondary part 28 with the caps 30 on the other hand may be decoupled by exerting a force on the whole of the secondary part 28 with the caps 30 that is directed away from the implants 11 and the primary parts 26. For example, this may be done when it is desired to clean the various components of the telescope/cone construction 2.

The accuracy with which the various components of the telescope/cone construction 2 need to be manufactured and placed in the mouth of a user person is very high. The position of the various primary parts 26 needs to be such that it is actually possible to remove the whole of the secondary part 28 with the caps 30 and put it back in place again. Moreover, in view of obtaining a secure frictional coupling, it is important that the caps 30 can be arranged on the primary parts 26 in a tightly-fitting fashion. It is preferred when cad-cam is used to manufacture the various components of the telescope/cone construction 2 which need to be made to size.

FIG. 6 shows a portion of an assembly 3 in a preferred embodiment of the invention. FIG. 6 shows the assembly 3 in a mounted condition, wherein it is anchored in a jaw 10 of a user person.

Like the telescope/cone construction 2, the assembly 3 comprises a number of implants 11, wherein the minimum number of implants 11 is two, and primary parts 26 which are screwed on the implants 11 in the mounted condition of the assembly 3, wherein screws 16 are applied. In FIG. 6, one of the implants 11 and a primary part 26 connected thereto is shown, wherein a screw 16 may also be seen. A whole of an implant 11 and a primary part 26 connected thereto is also shown in FIG. 8, wherein the screw 16 is omitted for sake of clarity.

The assembly 3 further comprises a secondary part 28, of which a portion is shown in FIG. 6. Additionally, this portion is separately shown in FIG. 9. At one side, the secondary part 28 is provided with spaces 29 for accommodating the primary parts 26, wherein a frictional coupling between the primary parts 26 and the secondary part 28 has been established. In the assembly 3, application of the caps 30 of the telescope/cone construction 2 is not necessary. In this construction, shape and size of the primary parts 26 and the spaces 29 in the secondary part as desired can be adapted to each other in such a way that the fitting of the secondary part 28 on the primary parts 26 is more loose or, on the other hand, tighter.

A special aspect of the assembly 3 is the fact that the secondary part 28 is provided with holes 32 giving access to the spaces 29 from another side than the side in which the spaces 29 are situated, while the primary parts 26 are provided with through-holes 27. On the basis of the presence of the said holes 27, 32, the assembly 3 offers two possibilities which are not present with the telescope/cone construction 2.

In the first place', it is possible to connect the primary parts 26 to the implants 11 while they are situated in the spaces 29 in the secondary part 28. Consequently, the secondary part 28 can be used as a transfer key for positioning the primary parts 26, wherein it may be guaranteed that once the primary parts 26 have been connected to the implants 11, the positioning of the primary parts 26 is such that the secondary part 28 fits exactly thereon. Establishing a connection between a primary part 26 and an implant 11 while the primary part 26 is situated in a space 29 of the secondary part 28 takes place by inserting the screw 16 in the primary part 26 and up to in the implant 11, through a hole 32 in the secondary part 28, and subsequently putting the thread 22 on the shank 23 of the screw 16 to engagement with the thread 18 of the implant 11.

In the second place, it is possible to fix the secondary part 28 on the primary parts 26. To this end, a second screw 33 can be applied, as is shown in FIG. 7, wherein a portion of the hole 27 in the primary part 26 which is located at the side of the connection to the secondary part 28 has internal thread 34. Also in this case, the holes 32 of the secondary part 28 may have two portions having different diameters, wherein it is realized that a head 35 of the screw 33 abuts against a transition surface 36 between the two portions, while a shank 37 of the screw 33 is allowed to pass on to the primary part 26 without hindrance.

Thus, in applying the assembly 3, it is possible to choose a completely fixedly mounted variant, or to realize a detachable construction. This is an important advantage with respect to the known constructions 1, 2. Furthermore, arranging and positioning the primary parts 26 is facilitated. By way of explanation, a possible way of manufacturing the various components of the assembly 3 and the way in which these components are placed in the jaw 10 of a user person will be described below.

In the first place, the implants 11 are provided, wherein the implants 11 do not need to be manufactured as such, but may be implants 11 known per se. The implants 11 are inserted in the jaw 10 of a user person. When the jaw 10 has been healed after this treatment, and the implants 11 are having a definitive position in the jaw 10, an imprint is made of the implants 11. On the basis of this imprint, a model is manufactured, wherein the positioning of the implants in the model corresponds to the positioning of the actual implants 11. Subsequently, this model is scanned in a computer, after which the primary parts 26 and the secondary part 28 are designed with the help of the computer. The parts 26, 28 are manufactured once the design is ready. A technique which is especially suitable to be applied in the process is a cad-cam milling technique.

The primary parts 26 are manufactured in two identical sets, wherein one set is destined to be used in the model, and wherein another set is destined to be used in the actual assembly 3. Inclination angles of the conical shape of the primary parts 26 and of the spaces 29 in the secondary part 28 can be chosen such as to be somewhat deviating with respect to each other, in case it is desired to realize a somewhat more loose frictional coupling of the secondary part 28 on the primary parts 26. It is also possible to adapted tolerances thereto.

After the primary parts 26 and the secondary part 28 have been formed, these parts 26, 28 can be fitted in the mouth of a user person. In the process, the primary parts 26 are definitively screwed to the implants 11 which are present in the mouth, by putting screws 16 at a proper position with respect to the primary parts 26 and the implants 11, through the holes 32 in the secondary part 28, and screwing them in the thread 18 of the implants 11. Subsequently, the secondary part 28 is finished. When the secondary part 28 is ready, it is possible to choose for realizing a fixed connection or a detachable connection to the primary parts 26. In the first case, screws 33 are applied to fix the secondary part 28 to the primary parts 26, wherein the screws 33 are screwed in the thread 34 of the primary parts 26.

For sake of completeness, it is noted that when the user person has a temporary facility until the assembly 3 is definitively placed, it needs to be adapted after arranging the primary parts 26.

It is possible to manufacture the assembly 3 according to the invention in an exceedingly accurate way. An accurate positioning of the various components of the assembly 3 is also possible, wherein the primary parts 26 are directly put in a desired place and in a desired orientation with the help of the secondary part 28. Among other things, due to the fact that the positioning of the components of the assembly 3 can take place in a way that may be carried out well, the cost prize of the assembly 3 can be kept within limits.

A notable advantage of the assembly 3 according to the invention is the fact that there is a choice between a fixed and a detachable construction. Furthermore, an application of computer-based techniques has the advantage that information regarding the various components of the assembly 3 may remain stored. On the basis thereof, it is possible, for example, to manufacture new primary parts 26, and to adapt the tolerance, if so desired, when loss of retention occurs in the course of time of use of the assembly 3.

It will be clear to a person skilled in the art that the scope of the invention is not limited to the examples discussed above, but that various amendments and modifications thereof are possible without deviating from the scope of the invention as defined in the appended claims.

In the foregoing, an assembly 3 which is destined to be anchored in a jaw of a user person, and which serves for supporting at least one artificial dental element, has been described. The assembly 3 comprises at least two implants 11 which are destined to be inserted in a jaw 10 of a user person; a primary part 26 per implant 11, which is destined to be placed on the implant 11 and to be connected to the implant 11, and which is provided with a through-hole 27; and a secondary part 28 which is destined to be placed on the primary parts 26. To this end, the secondary part 28 has spaces 29 at one side for receiving the primary parts 26. At another side, at the position of the spaces 29, the secondary part 28 has holes 32 giving access to the spaces 29. As a consequence, it is possible to reach the primary parts 26 for the purpose of fixing them in the implants 11, and to keep these parts 26 in a desired positioning with the help of the secondary part 28 at the same time. Also, on the basis of the fact that the primary parts 26 may be reached through the secondary part 28, a choice between a detachable frictional coupling and a fixed connection between the secondary part 28 and the primary parts 26 is possible.

1. Assembly which is destined to be anchored in a jaw of a user person, and which serves for supporting at least one artificial dental element, comprising:
at least two implants which are destined to be inserted in a jaw of a user person;
a primary part per implant, which is destined to be placed on the implant and to be connected to the implant; and
a secondary part which is destined to be placed on the primary parts, which has spaces for receiving the primary parts arranged therein at one side, and which, at another side, and at the position of the spaces, has holes giving access to the spaces
wherein the primary part is provided with a through-hole.

2. Assembly according to claim 1, further comprising an attachment element per primary part for realizing a connection of the primary part to the implant, wherein the implants (11) are provided with a hole, wherein the attachment element is adapted to be moved in its entirety up to in the hole of the primary part, through the hole in the secondary part, and wherein a portion of the attachment element is adapted to moved up to in the hole of the implant, through the hole in the primary part.

3. Assembly according to claim 2, wherein the attachment element comprises a screw, and wherein at least a portion of a surface of the implant is provided with internal thread at the position of the hole.

4. Assembly according to claim 1, further comprising an attachment element per primary part for realizing a connection of the secondary part to the primary part, wherein a portion of the attachment element is adapted to be moved up to in the hole of the primary part, through the hole in the secondary part).

5. Assembly according to claim 4, wherein the attachment element comprises a screw, and wherein at least a portion of a surface of the primary part is provided with internal thread (34) at the position of the hole.

6. Assembly according to claim 1, wherein the primary parts are shaped like a truncate cone.

7. Assembly according to claim 1, wherein a shape of the spaces which are situated in the secondary part is adapted to a shape of the primary parts, in order to be capable of snugly receiving the primary parts.

8. (canceled)

9. Method for placing an assembly according to claim 1 on implants as being present in a jaw of a user person, comprising:
placing the primary parts on the implants, and the secondary part on the primary parts; and
connecting the primary parts to the implants while these parts are situated in the spaces in the secondary part, by applying connection elements, wherein the attachment elements are moved through the holes in the secondary part.

10. Assembly according to claim 2, further comprising an attachment element per primary part for realizing a connection of the secondary part to the primary part, wherein a portion of the attachment element is adapted to be moved up to in the hole of the primary part, through the hole in the secondary part.

11. Assembly according to claim 3, further comprising an attachment element per primary part for realizing a connection of the secondary part to the primary part, wherein a portion of the attachment element is adapted to be moved up to in the hole of the primary part, through the hole in the secondary part.

12. Assembly according to claim 3, wherein the primary parts are shaped like a truncate cone.

13. Assembly according to claim 4, wherein the primary parts are shaped like a truncate cone.

14. Assembly according to claim 5, wherein the primary parts are shaped like a truncate cone.

15. Assembly according to claim 4, wherein a shape of the spaces which are situated in the secondary part is adapted to a shape of the primary parts, in order to be capable of snugly receiving the primary parts.

16. Assembly according to claim 5, wherein a shape of the spaces which are situated in the secondary part is adapted to a shape of the primary parts, in order to be capable of snugly receiving the primary parts.

17. Assembly according to claim 6, wherein a shape of the spaces which are situated in the secondary part is adapted to a shape of the primary parts, in order to be capable of snugly receiving the primary parts.

18. Method for placing an assembly according to claim 2 on implants as being present in a jaw of a user person, comprising:
placing the primary parts on the implants, and the secondary part on the primary parts; and
connecting the primary parts to the implants while these parts are situated in the spaces in the secondary part, by applying connection elements, wherein the attachment elements are moved through the holes in the secondary part.

19. Method for placing an assembly according to claim 3 on implants as being present in a jaw of a user person, comprising:
placing the primary parts on the implants, and the secondary part on the primary parts; and
connecting the primary parts to the implants while these parts are situated in the spaces in the secondary part, by applying connection elements, wherein the attachment elements are moved through the holes in the secondary part.

20. Method for placing an assembly according to claim 4 on implants as being present in a jaw of a user person, comprising:
placing the primary parts on the implants, and the secondary part on the primary parts; and
connecting the primary parts to the implants while these parts are situated in the spaces in the secondary part, by applying connection elements, wherein the attachment elements are moved through the holes in the secondary part.

21. Method for placing an assembly according to claim 5 on implants as being present in a jaw of a user person, comprising:
placing the primary parts on the implants, and the secondary part on the primary parts; and
connecting the primary parts to the implants while these parts are situated in the spaces in the secondary part, by applying connection elements, wherein the attachment elements are moved through the holes in the secondary part.
